(19) United States
(12) Patent Application Publication
(10) Pub. No.: US 2007/0140270 A1
(43) Pub. Date: Jun. 21, 2007

(54) Device, method and computer program product for controlling reception of broadcast content

(75) Inventor: Matti Hulkkonen, Helsinki (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/312,265

(22) Filed: Dec. 20, 2005

(51) Int. Cl. H04J 3/16; H04L 12/28; H04L 1/00; H04J 3/18; H04J 3/22; H04L 12/56; H04L 12/26

(52) U.S. Cl. 370/401; 370/477; 370/465; 370/229

(57) ABSTRACT

A device for controlling reception of broadcast content includes a receiving module and an output interface. The receiving module receives broadcast content from a source. The output interface communicates the received broadcast content to a terminal. The device is configured to determine a state of the terminal. The device is further configured to provide communication to the source directing the source to stop sending broadcast content directed to the device in response to the terminal being determined to be in a predefined state.

### FIELD OF THE INVENTION

Embodiments of the present invention generally relate to systems and methods for receiving broadcast content and, more particularly, to an apparatus, method and computer program product for performing operations with respect to receiving broadcast content.

### BACKGROUND OF THE INVENTION

The deployment of advanced high bit-rate networks has opened up new opportunities for delivering a host of services in a way that was not possible with earlier networks. Examples of such deliverable services that have shown promise include Digital Video Broadcasting (DVB) and internet protocol television (IPTV). In this regard, DVB-T, which is related to DVB-C (cable) and DVB-S (satellite), is the terrestrial variant of the DVB standard. As is well known, DVB-T is a wireless point-to-multipoint data delivery mechanism developed for digital TV broadcasting, and is based on the MPEG-2 transport stream for the transmission of video and synchronized audio. DVB-T has the capability of efficiently and simultaneously transmitting large amounts of data over a broadcast channel to a high number of users. DVB-H (handheld), which is also related to DVB-T, can provide such increased performance particularly for wireless data delivery to handheld devices.

Digital broadband data broadcast networks are known. As mentioned, an example of such a network enjoying popularity in Europe and elsewhere world-wide is DVB which, in addition to the delivery of television content, is capable of delivering data, such as Internet Protocol (IP) data. Other examples of broadband data broadcast networks include Japanese Terrestrial Integrated Service Digital Broadcasting (ISDB-T), Digital Audio Broadcasting (DAB), Digital Multimedia Broadcasting (DMB) and MBMS, and those networks provided by the Advanced Television Systems Committee (ATSC). In many such systems, a containerization technique is utilized in which content for transmission is placed into MPEG-2 packets which act as data containers. Thus, the containers can be utilized to transport any suitably digitized data including, but not limited to High Definition TV, multiple channel Standard definition TV (PAUNTSC or SECAM) and, of course, broadband multimedia data and interactive services.

In IPTV, a television signal is encoded in MPEG-2 or MPEG-4 over IP. A broadcast receiving terminal, such as an IP set top box, decodes the television signal and interfaces to a standard TV set, DVD player, video recorder etc. In response to an instruction to the set top box to change to a new channel, an internet group management protocol (IGMP) leave message is typically sent to the network to indicate that the network should stop sending the current channel. Then the set top box begins receiving the new channel.

The use of a broadband delivery technique such as IPTV or any other internet protocol (IP) multicast stream, has enabled systems employing terminals, for example, mobile telephones, mobile handheld televisions, mobile computers, televisions, gaming systems, etc., to receive high quality broadcast data via either wireline or wireless delivery mechanisms. In such systems, the terminal typically includes a display portion for displaying the broadcast data which is received by a broadcast receiver in communication with the terminal. However, it is common that the broadcast receiving terminal continues to receive broadcast data even after the terminal is turned off. Accordingly, a digital subscriber line (DSL), wireless network, or other IP multicast streaming mechanism may have large amounts of bandwidth unnecessarily used. Such unnecessary use of bandwidth may overload networks, block reception of another broadcast channel to another broadcast receiver at the same location, and if the broadcast data is pay per view, continue charges for received content that is not viewed. Accordingly, there is a need to provide a mechanism by which such unnecessary use of bandwidth may be prevented.

### SUMMARY OF THE INVENTION

In light of the foregoing background, exemplary embodiments of the present invention provide an improved apparatus, method and computer program product for controlling receipt of broadcast content. Specifically, exemplary embodiments of the present invention include a mechanism by which unnecessary use of bandwidth may be avoided by sending a message to a network to inform the network to stop sending data to a receiver when a display terminal is powered off. Accordingly, when the display terminal is powered off, the receiver stops receiving broadcast data and therefore stops using bandwidth unnecessarily. This is of particular advantage in, for example, IPTV applications.

According to one aspect of the present invention, a device for controlling reception of broadcast content is provided. The device includes a receiving module and an output interface. The receiving module receives broadcast content from a source. The output interface communicates the received broadcast content to a terminal. The device is configured to determine a state of the terminal. The device is further configured to provide communication to the source directing the source to stop sending broadcast content directed to the device in response to the terminal being determined to be in a predefined state.

According to another aspect of the present invention, a method for controlling reception of broadcast content received from a network source is provided. The method includes determining a state of the terminal, providing broadcast content to the terminal in response to a first state of the terminal being determined, and communicating to the source a direction to stop sending the broadcast content in response to a second state of the terminal being determined.

According to another aspect of the present invention, a computer program product for controlling reception of broadcast content received from a network source is provided. The computer program product includes a computer-readable storage medium having computer-readable program code portions stored therein. The computer-readable program code portions include first, second and third executable portions. The first executable portion is for determining a state of the terminal. The second executable portion is for providing broadcast content to the terminal in response to a first state of the terminal being determined. The third executable portion is for communicating to the source a direction to stop sending the broadcast content in response to a second state of the terminal being determined.

Therefore, the terminal, method and computer program product of exemplary embodiments of the present invention may solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one exemplary embodiment of the present invention;

FIG. 2 is a schematic block diagram of an entity capable of operating as a terminal, origin server, digital broadcast receiving terminal and/or a digital broadcaster, in accordance with exemplary embodiments of the present invention;

FIG. 3 is a functional block diagram of a digital broadcast receiving terminal, in accordance with one exemplary embodiment of the present invention;

FIG. 4 illustrates a control flow diagram according to a method of controlling reception of broadcast content, in accordance with an exemplary embodiment of the present invention;

FIG. 5 illustrates a control flow diagram according to another method of controlling reception of broadcast content, in accordance with an exemplary embodiment of the present invention; and

FIG. 6 is a flowchart of methods, systems and program products for controlling reception of broadcast content, in accordance with an exemplary embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

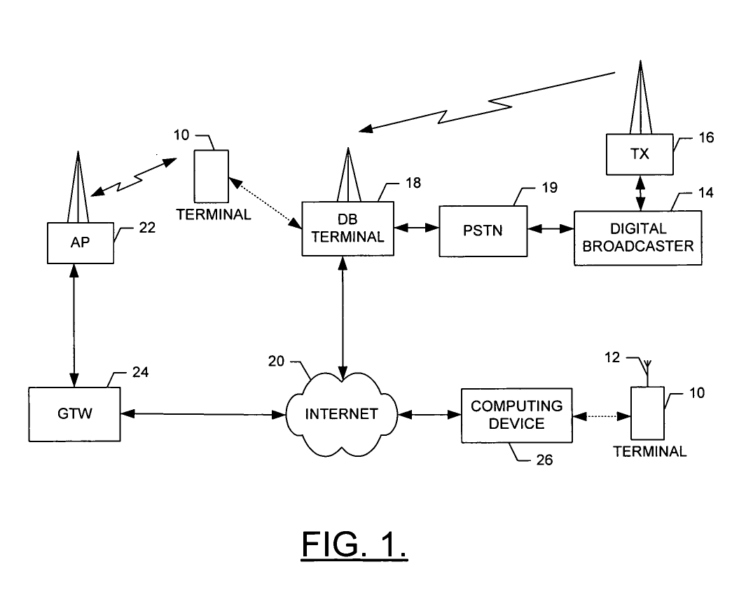

Referring to FIG. 1, an illustration of one type of terminal and system that would benefit from the present invention is provided. As shown, a terminal 10 may include an antenna 12 for transmitting signals to and for receiving signals from a digital broadcaster 14 via a digital broadcast network, such as a terrestrial digital video broadcasting (e.g., IPTV, DVB-T, DVB-H, ISDB-T, ATSC, etc.) network. The terminal 10 may be, for example, a television, or a mobile terminal such as a mobile television, mobile telephone, etc. As will be appreciated, by directly or indirectly connecting the terminal 10 and the digital broadcaster 14, the terminals can receive content, such as content for one or more television, radio and/or data channels, from the digital broadcaster 14. In this regard, the digital broadcaster 14 can include, or be coupled to, a transmitter (TX) 16, such as a IPTV TX. Similarly, the terminal 10 can include a receiver, such as a IPTV receiver (not shown). The terminal 10 can be capable of receiving content from any of a number of different entities in any one or more of a different number of manners. In one embodiment, for example, the terminal 10 may be a mobile terminal capable of transmitting and/or receiving data, content or the like in accordance with an IPTV technique. In such an embodiment, the terminal 10 may include antennae for receiving content from the IPTV TX, and for transmitting signals to and for receiving signals from a base site or base station (BS) of a cellular network (not shown).

In addition to, or in lieu of, directly coupling the terminal 10 to the digital broadcaster 14 via the TX 16, the terminal 10 can be coupled to a digital broadcast (DB) receiving terminal 18 which, in turn, can be coupled to the digital broadcaster 14, such as directly and/or via the TX 16 or via a Public Switched Telephone Network (PSTN) 19 using, for example, a DSL connection. In such instances, the digital broadcast receiving terminal 18 can comprise a receiver, such as an IPTV receiver in the form of a set top box. Alternatively, the terminal 10 can be locally coupled to the digital broadcast receiving terminal 18, such as via a personal area network. In one exemplary embodiment, however, the terminal 10 can additionally or alternatively be indirectly coupled to the digital broadcast receiving terminal 18 via a data network, such as a local area network (LAN), a metropolitan area network (MAN), and/or a wide area network (WAN) like the Internet 20. The terminal 10 can be directly coupled to the Internet 20, or indirectly coupled to the Internet 20. For example, the terminal 10 can be coupled to the Internet 20, and thus the digital broadcast receiving terminal 18, via a wireless access point (AP) 22 and/or a gateway (GTW) 24. Additionally or alternatively, for example, the terminal 10 can be coupled to the Internet 20 via one or more other computing devices 26, such as personal computers, server computers or the like.

It should be noted that although a PSTN 19 is shown providing communication between the digital broadcast receiving terminal 18 and the digital broadcaster 14, the PSTN 19 may be entirely omitted or replaced with another network.

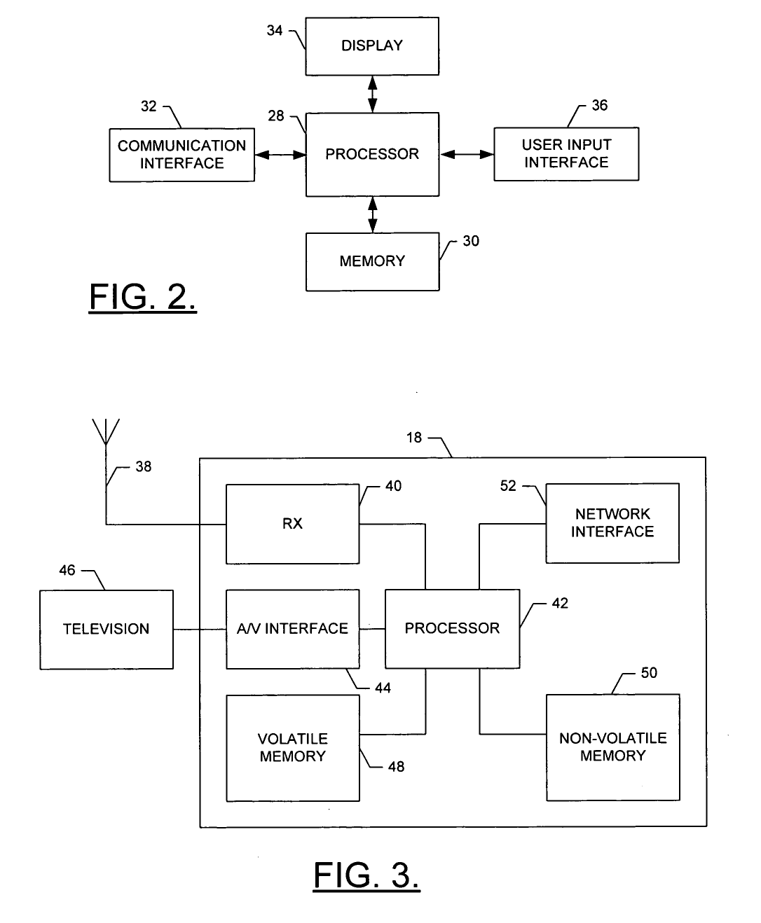

Referring now to FIG. 2, a block diagram of an entity capable of operating as a terminal 10, digital broadcaster 14 and/or digital broadcast receiving terminal 18 is shown in accordance with one embodiment of the present invention. Although shown as separate entities, in some embodiments, one or more entities may support one or more of a terminal 10, digital broadcaster 14 and/or digital broadcast receiving terminal 18, logically separated but co-located within the entities. For example, a single entity may support a logically separate, but co-located, terminal 10 and digital broadcast receiving terminal 18. Also, for example, a single entity may support a logically separate, but co-located digital broadcast receiving terminal 18 and digital broadcaster 14.

The entity capable of operating as a terminal 10, digital broadcaster 14 and/or digital broadcast receiving terminal 18 includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 2, the entity can include a processor 28 connected to a memory 30. The memory 30 can comprise volatile and/or non-volatile memory, and stores content, data or the like. For example, the memory 30 stores content transmitted from, and/or received by, the entity. Also for example, the memory 30 stores client applications, instructions or the like for the processor to perform steps associated with operation of the entity in accordance with exemplary embodiments of the present invention. As explained below, for example, the memory 30 can store client application(s), such as a conventional text viewer, audio player, video player, multimedia viewer or the like, for consuming content for one or more television, radio and/or data channels.

Also, for example, the memory 30 can store a digital rights management (DRM) engine integral or otherwise in communication with one or more client application(s) such that the DRM engine can control the consumption of content based upon a DRM technique. Such a DRM engine may be configured in accordance with any of a number of different DRM techniques including, for example, that defined by the Open Mobile Alliance (OMA) Digital Rights Management specification. Further, the memory can store a decryption module integral or otherwise in communication with one or more client application(s) and the DRM engine such that the encryption/decryption module can encrypt content for consumption by the client application(s). In this regard, the decryption module can be configured to decrypt content in accordance with any of a number of different techniques by which the content is encrypted including, for example, Internet Protocol Security (IPSec), Secure Real Time Transport Protocol (SRTP) or the like.

As described herein, the client application(s), DRM engine and decryption module each comprise software operated by the respective entities. It should be understood, however, that any one or more of the client applications, DRM engine and decryption module described herein can alternatively comprise firmware or hardware, without departing from the spirit and scope of the present invention. Generally, then, the terminal 10, digital broadcaster 14 and/or digital broadcast receiving terminal 18 can include one or more logic elements for performing various functions of one or more client application(s), DRM engine and/or decryption module. As will be appreciated, the logic elements can be embodied in any of a number of different manners. In this regard, the logic elements performing the functions of one or more client applications, DRM engine and/or decryption module can be embodied in an integrated circuit assembly including one or more integrated circuits integral or otherwise in communication with a respective network entity (i.e., terminal 10, origin server, digital broadcast receiving terminal 18, digital broadcaster 14, etc.) or more particularly, for example, a processor 28 of the respective network entity.

In addition to the memory 30, the processor 28 can also be connected to at least one interface or other means for displaying, transmitting and/or receiving data, content or the like. In this regard, the interface(s) can include at least one communication interface 32 or other means for transmitting and/or receiving data, content or the like, as well as at least one user interface that can include a display 34 and/or a user input interface 36. The user input interface 36, in turn, can comprise any of a number of devices allowing the entity to receive data from a user, such as a keypad, a touch display, a joystick or other input device. As more particularly explained below, for example, the user input interface 36 can include one or more directional keys (hard and/or soft keys) for directionally selecting ordered items, such as ordered channels of content.

Reference is now made to FIG. 3, which illustrates a functional block diagram of a digital broadcast receiving terminal 18, in accordance with one embodiment of the present invention. As shown, the digital broadcast receiving terminal 18 includes an antenna 38 for receiving signals from a digital broadcaster 14 and feeding the signals into a receiving module, such as a receiver (RX) 40. In turn, the receiver 40 is capable of decrypting, demodulating and/or demultiplexing the signals, such as to extract content data. The receiver 40 can feed the content data to a processor 42, which can thereafter decode the content data. The processor 42 can then feed the decoded signal into an output interface such as an audio/video (A/V) interface 44, which can convert signals to a form suitable for display by the terminal 10, such as a television set.

The digital broadcast receiving terminal 18 can include volatile memory 48, such as volatile Random Access Memory (RAM) including a cache area for the temporary storage of data. The digital broadcast receiving terminal 18 can also include non-volatile memory 50, which can be embedded and/or may be removable. The non-volatile memory 50 can additionally or alternatively comprise an EEPROM, flash memory, hard disk or the like. The memories can store any of a number of pieces of information, content and data, used by the digital broadcast receiving terminal 18 to implement the functions of the digital broadcast receiving terminal 18. For example, as indicated above, the memories can store content, such as that received from a digital broadcaster 14.

The digital broadcast receiving terminal 18 can also include one or more interface means for sharing and/or obtaining data from electronic devices, such as terminals 10 and/or digital broadcasters 14. More particularly, the digital broadcast receiving terminal can include a network interface 52, for sharing and/or obtaining data from a network, such as the Internet 20 or the PSTN 19. For example, the digital broadcast receiving terminal 18 can include an Ethernet Personal Computer Memory Card International Association (PCMCIA) card configured to transmit and/or receive data to and from a network, such as the Internet 20.

The digital broadcaster 14 can be capable of directly or indirectly transmitting content to a digital broadcast receiving terminal 18 and/or a terminal 10, such as in accordance with a digital broadcasting technique, such as DVB-T. In this regard, the digital broadcaster 14 can be capable of transmitting broadcast content via satellite, a DSL connection or other wired or wireless communication.

In accordance with a number of digital broadcasting techniques, such as DVB-H, Internet Protocol (IP) Datacasting (IPDC) can be utilized to provide audio, video and/or other content to terminals 10. In this regard, the digital broadcaster 14 can be capable of providing IP datacasting content to the terminal 10 utilizing a digital broadcasting technique. DVB-H, for example, uses MPEG-2 transport streams, and as such, IP data can be encapsulated into DVB transmission signals sent from the digital broadcaster 14, or more particularly the TX 16. Data streams including IP datagrams can be supplied from several sources, and can be encapsulated by an IP encapsulator (not shown). The IP encapsulator, in turn, can feed the encapsulated IP data streams into the digital broadcasting (e.g., DVB-H) network.

The encapsulated IP data streams can then be transported to one or more transmission sites, where the transmission sites form cells of the data broadcasting network. For example, the encapsulated IP data streams can be transported to one or more transmission sites on an MPEG-2 transport stream for subsequent transmission over the air directly to the terminals, or to a receiver station serving one or more terminals. As will be appreciated, the MPEG-2 transport stream, from production by the IP encapsulator, to reception by the terminals or the receiver station, may be unidirectional in nature. In this regard, IP packets containing the data can be embedded in multi-protocol encapsulation (MPE) sections that are transported within transport stream packets.

In an exemplary embodiment, the audio/video interface 44 includes a terminal power indication module (TPIM) 56. The terminal power indication module 56 may be used to enable broadcast channel control at the digital broadcast receiving terminal 18. For example, the terminal power indication module 56 may be configured to communicate a power state of the terminal 10 as ON or OFF to the processor 42. In response to the power state of the terminal 10 being ON, the processor 42 permits normal operation of the digital broadcast receiving terminal 18, i.e., IP datagrams directing broadcast channel control responsive to user input at the terminal 10 are accepted. In response to the power state of the terminal 10 being OFF, the processor 42 may enable the digital broadcast receiving terminal 18 to send a message to the digital broadcaster 14 informing the digital broadcaster 14 to stop sending any digital broadcast data to the digital broadcast receiving terminal 18. Accordingly, in response to the terminal 10 being turned off, the digital broadcast receiving terminal 18 stops receiving digital broadcast data and thereby prevents unnecessary usage of digital broadcast network bandwidth. It should be noted that the terminal power indication module 56 may be embodied as any means capable of determining a power state of the terminal 10 which may subsequently be communicated to the processor 42. As such, the terminal power indication module 56 need not be disposed in the audio/video interface 44, but may be disposed in or otherwise in association with any portion of the digital broadcast receiving terminal 18 that is capable of communication with the processor 42. In an exemplary embodiment, the terminal power indication module 56 may be embodied in software implemented in the audio/video interface 44. Alternatively, in another exemplary embodiment, the terminal power indication module 56 may be embodied in hardware implemented in the audio/video interface 44, such as, for example, a switch capable of sensing and indicating a power state of the terminal 10. Furthermore, it should be noted that the processor 42 may cause sending of the message to the digital broadcaster 14 to stop further digital broadcast data from being sent to the digital broadcast receiving terminal 18 by any suitable means. Thus, the processor 42 may enable sending of the message or send the message with or without assistance from other system elements.

In an exemplary embodiment, internet group management protocol (IGMP) may be used to report multicast group memberships to multicast routers of an IPTV system. In other words, IGMP messages encapsulated in IP datagrams may be used for broadcast channel control at the digital broadcast receiving terminal 18. Thus, IGMP messages transmitted to the digital broadcaster 14 inform the digital broadcaster 14 of which broadcast channel, if any, the digital broadcast receiving terminal 18 wishes to receive. IGMPv2 is an exemplary version of the IGMP messages which is specified in RFC 2236. IGMP message types include, for example, membership query messages, membership report messages, leave group messages and join group messages. Thus, the message to the digital broadcaster 14 informing the digital broadcaster 14 to stop sending any digital broadcast data to the digital broadcast receiving terminal 18 may be embodied as an IGMP leave group message.

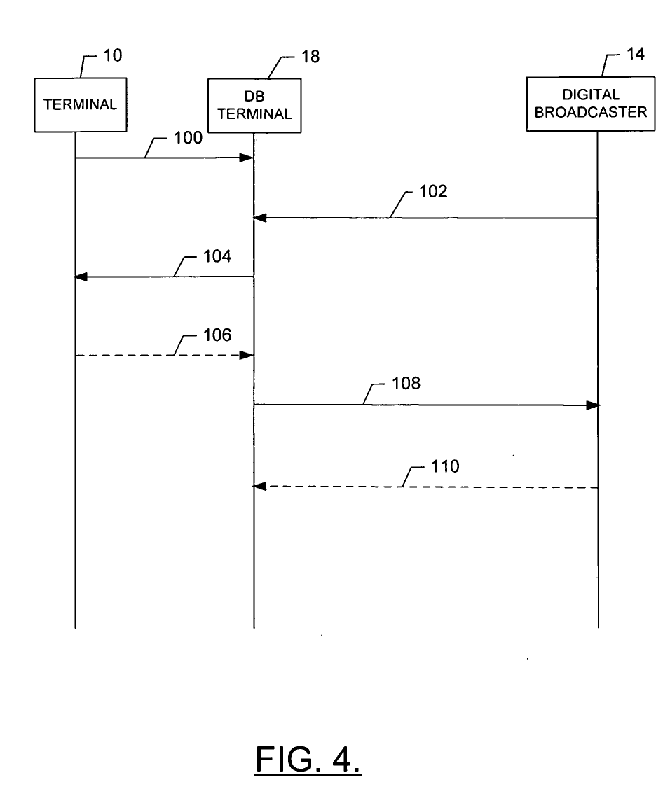

FIG. 4 illustrates a control flow diagram according to a method of controlling reception of broadcast content, in accordance with an exemplary embodiment of the present invention. As shown in FIG. 4, when a terminal power on signal 100 is received by the digital broadcast receiving terminal 18, the digital broadcast receiving terminal 18 receives broadcast data 102 from the digital broadcaster 14 and communicates channel broadcast data 104 to the terminal 10. In response to a loss of the terminal power on signal as indicated by the dashed line at 106, the digital broadcast receiving terminal 18 sends a leave group message 108 to the digital broadcaster 14 and the digital broadcaster 14 stops transmitting broadcast data to the digital broadcast receiving terminal 18 as indicated by the dashed line 110.

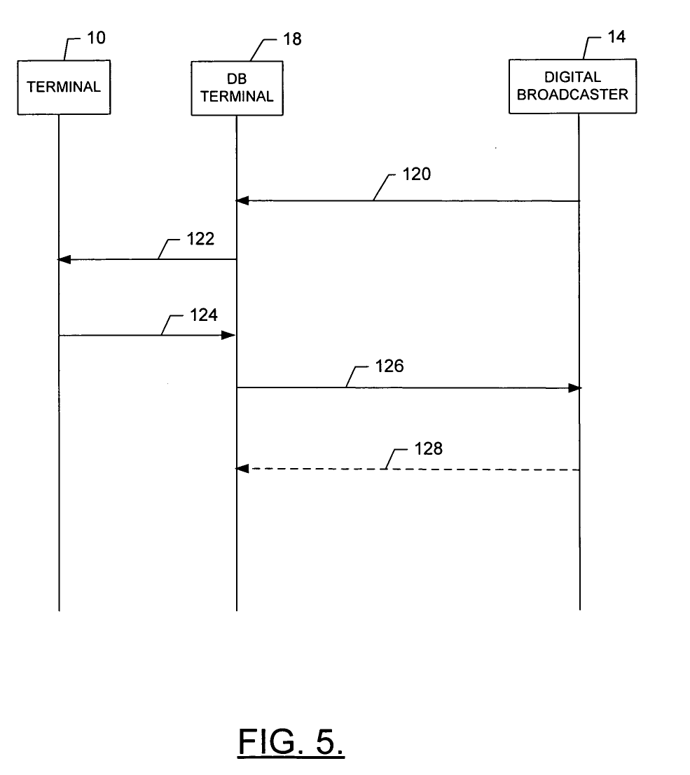

FIG. 5 illustrates a control flow diagram according to another method of controlling reception of broadcast content, in accordance with an exemplary embodiment of the present invention. As shown in FIG. 5, the digital broadcast receiving terminal 18 receives broadcast data 120 from the digital broadcaster 14 and communicates channel broadcast data 122 to the terminal 10. In response to receipt of a terminal power off signal 124, the digital broadcast receiving terminal 18 sends a leave group message 126 to the digital broadcaster 14 and the digital broadcaster 14 stops transmitting broadcast data to the digital broadcast receiving terminal 18 as indicated by the dashed line 128.

It should be noted that in either the embodiment of FIG. 4 or FIG. 5, a delay may be inserted between a loss of power at the terminal 10 and transmission of the leave group message 108 or 126. Such a delay may be set to a predetermined time chosen to ensure that the terminal 10 was intentionally powered off. Accordingly, cycling of the digital broadcaster 14 stopping and starting transmission of broadcast content to the digital broadcast receiving terminal 18 may be prevented in cases where the terminal 10 is inadvertently powered off and immediately powered back on.

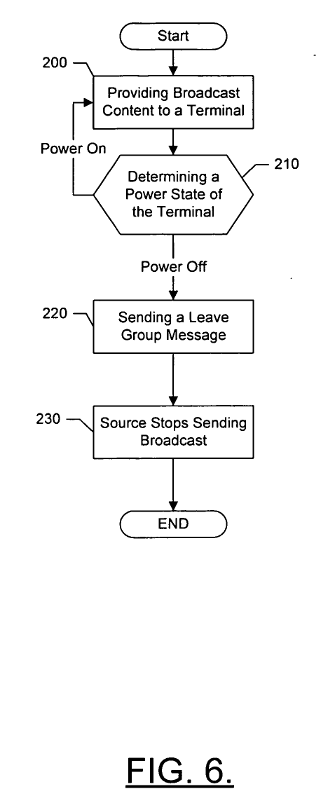

In summary, FIG. 4 illustrates transmission of a leave group message in response to a negative indication of power loss in the terminal 10 (i.e., loss of power on signal indicates loss of terminal power), while FIG. 5 illustrates transmission of a leave group message in response to a positive indication of power loss at the terminal 10 (i.e., presence of power off signal indicates loss of terminal power). It should be noted that although the exemplary embodiments described above with reference to FIGS. 4 and 5 describe cases in which a signal sent in response to the presence of terminal power and absence of terminal power, respectively, were used to illustrate means for controlling reception of broadcast content by the digital broadcast receiving terminal 18, any suitable means including a combination of such signals, or other means is also contemplated. Moreover, although FIGS. 4 and 5 each show specific exemplary embodiments, FIG. 6 shows a more general embodiment of the present invention.

FIG. 6 is a flowchart of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the flowchart. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowchart. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the flowchart.

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Referring now to FIG. 6, a method of controlling reception of broadcast content according to an exemplary embodiment is provided. Providing broadcast content to a terminal responsive to receipt of the broadcast data from a source occurs at operation 200. At operation 210, a power state of the terminal is determined. If the terminal is powered, broadcast content continues to be provided. However, if the terminal is not powered, a leave group message is sent at operation 220. In response to the leave group message, a source of the broadcast content secures sending the broadcast content at operation 230.

It should be noted that although the above described embodiments describe a leave group message being used to direct the digital broadcaster 14 to stop sending broadcast content to the digital broadcast receiving terminal 18, any message indicating that broadcast content should no longer be sent to the digital broadcast receiving terminal 18 is contemplated. Thus, the leave group message is simply an exemplary message with which the present invention may be practiced and should not be construed to limit the principles disclosed above.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is clamed is:

1. A device for controlling reception of broadcast content, the device comprising:
a receiving module for receiving broadcast content from a source;
an output interface for communicating the received broadcast content to a terminal,
wherein the device is configured to determine a state of the terminal, and the device is further configured to provide communication to the source directing the source to stop sending broadcast content directed to the device in response to the terminal being determined to be in a predefined state.

2. A device according to claim 1, wherein the device is configured to provide the communication via sending a message in response to the terminal being in a powered off state.

3. A device according to claim 2, wherein the message is an internet group management protocol (IGMP) leave message.

4. A device according to claim 1, wherein the terminal is a mobile terminal.

5. A device according to claim 1, wherein the terminal is a television.

6. A device according to claim 1, wherein the device is a broadcast receiving terminal.

7. A device according to claim 1, wherein the receiving module is configured to receive broadcast content from a digital broadcasting station.

8. A device according to claim 1, wherein the receiving module is configured to receive broadcast content from a satellite transmitter.

9. A device according to claim 1, wherein the state is determined in response to a loss of a terminal power on signal.

10. A device according to claim 1, wherein the state is determined in response to receipt of a terminal power off signal.

11. A method of controlling reception of broadcast content capable of delivery to a terminal, the broadcast content being received from a network source, the method comprising:
determining a state of the terminal;
providing broadcast content to the terminal in response to a first state of the terminal being determined; and
communicating to the source a direction to stop sending the broadcast content in response to a second state of the terminal being determined.

12. A method according to claim 11, wherein the communicating comprises sending a message to the source.

13. A method according to claim 12, wherein the sending a message comprises sending an internet group management protocol (IGMP) leave message.

14. A method according to claim 11, wherein the determined state is one of a powered on state and a powered off state.

15. A computer program product for controlling reception of broadcast content capable of delivery to a terminal, the broadcast content being received from a network source, the computer program product comprising a computer-readable storage medium having computer-readable program code portions stored therein, the computer-readable program code portions comprising:
a first executable portion for determining a state of the terminal;
a second executable portion for providing broadcast content to the terminal in response to a first state of the terminal being determined; and
a third executable portion for communicating to the source a direction to stop sending the broadcast content in response to a second state of the terminal being determined.

16. A computer program product according to claim 15, wherein the third executable portion comprises sending a message to the source.

17. A computer program product according to claim 15, wherein the third executable portion comprises sending an internet group management protocol (IGMP) leave message.

18. A computer program product according to claim 15, wherein third executable portion determines the state to be one of a powered on state and a powered off state.

19. A computer program product according to claim 18, wherein the first state is on.

20. A computer program product according to claim 18, wherein the second state is off.
